(19) United States
(12) Patent Application Publication
(10) Pub. No.: US 2025/0368058 A1
(43) Pub. Date: Dec. 4, 2025

(54) MULTIPORT CONVERTER FOR AUXILIARY POWER SUPPLY

(71) Applicant: UT-Battelle, LLC, Oak Ridge, TN (US)

(72) Inventors: Subho Mukherjee, Knoxville, TN (US); Vivek Sujan, Knoxville, TN (US); Omer C. Onar, Knoxville, TN (US); Md S. Chowdhury, Knoxville, TN (US)

(21) Appl. No.: 19/220,673

(22) Filed: May 28, 2025

Related U.S. Application Data
(60) Provisional application No. 63/652,688, filed on May 29, 2024.

(51) Int. Cl. B60L 50/75; B60L 55/00; H02M 1/00; H02M 3/335

(52) U.S. Cl. CPC B60L 50/75; B60L 55/00; H02M 1/009; H02M 3/33573; H02M 3/33576; B60L 2210/10; B60L 2210/42

(57) ABSTRACT

Auxiliary converters may be integrated with a main DC-DC converter through a multiport converter (MPC) so that electronic components of the main DC-DC converter can be shared with the auxiliary converters, enabling reduction in volume, weight, and cost.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of power conversion, and more particularly to a multi-port converter based auxiliary power supply for a heavy-duty fuel cell power train.

### BACKGROUND

Auxiliary power supplies are an often-implemented component of an electric vehicle (EV) power train. Although auxiliary power supplies often do not provide power to the main power train, the functioning of an EV may be impaired without auxiliary power supplies. For a heavy duty (HD) EV, the auxiliary power supplies can be derived from a 12 V and 24 V battery system, and reliable charging systems for these two batteries are useful for EV applications. These conventional charging systems in EV applications must be isolated from the main powertrain. Conventional auxiliary power architectures utilize independent isolated DC-DC converter modules followed by independent non-isolated modules for charging the auxiliary batteries. Such architectures increase cost, weight, and volume of the overall powertrain.

### SUMMARY

In general, one innovative aspect of the subject matter described herein can be embodied in a powertrain of a heavy-duty electric vehicle (HD EV). The powertrain may include a fuel-cell (FC) stack, an inverter DC bus, a 12 V battery bus, and a 24 V battery bus. The powertrain may include a multiport converter (MPC) including an input port, and first, second, and third output ports. The MPC may include interleaved DC-DC converter circuitry with first, second, third, and fourth phase legs, where the interleaved DC-DC converter circuitry may be electrically coupled to the FC stack through the input port and to the inverter DC bus through the first output port. The MPC may include first auxiliary power-supply circuitry including a first isolation transformer and fifth and sixth phase legs, where the fifth and sixth phase legs may be electrically coupled to respective mid-points of the first and third phase legs through the first isolation transformer, to the 12 V battery bus through the second output port, and to the 24 V battery bus through the third output port.

The MPC may include second auxiliary power-supply circuitry including a second isolation transformer and seventh and eighth phase legs, where the seventh and eighth phase legs are electrically coupled to 1) respective mid-points of the second and fourth phase legs through the second isolation transformer, 2) the 12 V battery bus through the second output port, and 3) the 24 V battery bus through the third output port, where the first auxiliary power-supply circuitry and the second auxiliary power-supply circuitry may be interleaved.

The foregoing and other embodiments can each optionally include one or more of the following features, alone or in combination. In particular, one embodiment includes all the following features in combination.

In some embodiments, phase legs each may include a respective half bridge.

In some embodiments, the interleaved DC-DC converter circuitry may be configured as a buck converter or a boost converter.

In some embodiments, controller circuitry may be communicatively coupled with the MPC and configured to control the first auxiliary power-supply circuitry and the second auxiliary power-supply circuitry in a decoupled manner.

In some embodiments, a traction inverter may be electrically coupled with the MPC through the inverter DC bus, and a motor may be electrically coupled with the traction inverter.

In general, one innovative aspect of the subject matter described herein can be embodied in a converter system for a heavy-duty electric vehicle (HD EV). The converter system may include a DC source, a traction inverter DC bus, a first auxiliary bus, and a second auxiliary bus. The converter system may include a multiport converter (MPC) with an input port, and first, second, and third output ports. The MPC may include first interleaved converter circuitry electrically coupled to the DC source through the input port and to the traction inverter DC bus through the first output port. The first interleaved converter circuitry may correspond to a DC-DC converter and may provide a first AC voltage and a second AC voltage. The MPC may include second interleaved converter circuitry operably coupled to the first AC voltage and the second AC voltage of the first interleaved converter circuitry. The second interleaved converter circuitry may be configured to provide first DC voltage, based at least in part on the first AC voltage, to the first auxiliary bus through the second output port. The second interleaved converter circuitry may be configured to provide second DC voltage, based at least in part on the second AC voltage, to the second auxiliary bus through the third output port.

The foregoing and other embodiments can each optionally include one or more of the following features, alone or in combination. In particular, one embodiment includes all the following features in combination.

In some embodiments, the second interleaved converter circuitry may include first auxiliary converter circuitry operably coupled to the first AC voltage of the first interleaved converter circuitry. The first auxiliary converter circuitry may be operably coupled to the second output port to provide power to the second output port. The second auxiliary converter circuitry may be operably coupled to the second AC voltage of the first interleaved converter circuitry, and the second auxiliary converter circuitry may be operably coupled to the third output port to provide power to the third output port.

In some embodiments, the converter system may include controller circuitry communicatively coupled with the first and second interleaved converter circuitries and configured to control the first auxiliary converter circuitry and the second auxiliary converter circuitry in a decoupled manner.

In some embodiments, the first auxiliary converter circuitry may be operably coupled to the third output port to provide power to the third output port, and where the second auxiliary converter circuitry may be operably coupled to the second output port to provide power to the second output port.

In some embodiments, the first auxiliary converter circuitry and the second auxiliary converter circuitry may be operated in an interleaved manner to provide power to both the second output port and the third output port to respectively generate the first DC voltage for the second output port and the second DC voltage for the third output port.

In some embodiments, the first interleaved converter circuitry may include first, second, third, and fourth phase legs. The first auxiliary converter circuitry may include a first isolation transformer and fifth and sixth phase legs, where the fifth and sixth phase legs may be electrically coupled to respective mid-points of the first and third phase legs through the first isolation transformer, to the first auxiliary bus through the second output port, and to the second auxiliary bus through the third output port.

In some embodiments, the second auxiliary converter circuitry may include a second isolation transformer and seventh and eighth phase legs, where the seventh and eighth phase legs may be electrically coupled to 1) respective mid-points of the second and fourth phase legs through the second isolation transformer, 2) the first auxiliary bus through the second output port, and 3) the second auxiliary bus through the third output port.

In some embodiments, the first auxiliary converter circuitry and the second auxiliary converter circuitry may be interleaved.

In some embodiments, the first, second, third, fourth, fifth, and sixth phase legs each may include a respective half bridge.

In some embodiments, the first interleaved converter circuitry may be configured as a buck converter or a boost converter.

In some embodiments, the converter system may include a traction inverter electrically coupled with the first interleaved converter circuitry through the traction inverter DC bus. The converter system may include a motor electrically coupled with the traction inverter.

In general, one innovative aspect of the subject matter described herein can be embodied in a converter system comprising a DC source; a traction inverter DC bus, a first auxiliary bus, and a second auxiliary bus. The converter system may include a multiport converter (MPC) including an input port, and first, second, and third output ports. The MPC may include first interleaved converter circuitry electrically coupled to the DC source through the input port and to the traction inverter DC bus through the first output port. The first interleaved converter circuitry may correspond to a DC-DC converter and provide a first AC voltage and a second AC voltage. The MPC may include second converter circuitry operably coupled to the first AC voltage and the second AC voltage of the first interleaved converter circuitry. The second converter circuitry may be configured to provide first DC voltage, based at least in part on the first AC voltage, to the first auxiliary bus through the second output port. The second converter circuitry may be configured to provide second DC voltage, based at least in part on the second AC voltage, to the second auxiliary bus through the third output port.

The foregoing and other embodiments can each optionally include one or more of the following features, alone or in combination. In particular, one embodiment includes all the following features in combination.

In some embodiments, the second converter circuitry may include first auxiliary converter circuitry operably coupled to the first AC voltage of the first interleaved converter circuitry. The first auxiliary converter circuitry may be operably coupled to the second output port to provide power to the second output port. The second auxiliary converter circuitry may be operably coupled to the second AC voltage of the first interleaved converter circuitry. The second auxiliary converter circuitry may be operably coupled to the third output port to provide power to the third output port.

In some embodiments, the first auxiliary converter circuitry may be operably coupled to the third output port to provide power to the third output port, and where the second auxiliary converter circuitry may be operably coupled to the second output port to provide power to the second output port.

In some embodiments, the first auxiliary converter circuitry and the second auxiliary converter circuitry may be operated in an interleaved manner to provide power to both the second output port and the third output port to respectively generate the first DC voltage for the second output port and the second DC voltage for the third output port.

In some embodiments, controller circuitry may be communicatively coupled with the first interleaved converter circuitry and the second converter circuitry and configured to control the first auxiliary converter circuitry and the second auxiliary converter circuitry in a decoupled manner.

In some embodiments, the second converter circuitry may include third auxiliary converter circuitry operably coupled to an AC voltage of the first interleaved converter circuitry. The third auxiliary converter circuitry may be operably coupled to a fourth output port to provide power to the fourth output port.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a multiport converter according to one embodiment.

FIG. 2 shows a multiport converter according to one embodiment.

FIG. 3 shows an auxiliary converter of FIG. 2 in one embodiment.

FIG. 4 shows a multiport converter according to one embodiment.

FIG. 5 shows the multiport converter of FIG. 4 with an additional auxiliary converter configuration.

FIG. 6 shows representative waveforms for the primary and secondary sides of an auxiliary converter in one embodiment.

FIG. 7A shows a representative voltage and current waveform in one embodiment.

FIG. 7B shows a representative voltage and current waveform in one embodiment.

FIG. 7C shows a representative voltage and current waveform in one embodiment.

FIG. 7D shows a representative voltage and current waveform in one embodiment.

FIG. 8A shows a representative voltage and current waveform in one embodiment.

FIG. 8B shows a representative voltage and current waveform in one embodiment.

FIG. 8C shows a representative voltage and current waveform in one embodiment.

FIG. 8D shows a representative voltage and current waveform in one embodiment.

FIG. 9 shows a control methodology according to one embodiment.

FIG. 10 shows switch current load in one embodiment.

FIG. 11 shows switch current load in one embodiment.

FIG. 12 shows load power control according to one embodiment.

FIG. 13 shows load power control according to one embodiment.

FIG. 14 shows load power control according to one embodiment.

### DESCRIPTION

A multi-port converter system according to one embodiment may be provided for generating power for multiple output ports. The multi-port converter system may include a main converter (e.g., DC-DC, DC-AC, AC-AC or AC-DC) from which one or more AC power signals may be obtained and provided as respective inputs to one or more auxiliary converters. Each of the one or more auxiliary converters may be coupled to a plurality of power outputs and configured to supply power to each of the plurality of power outputs. The multi-port converter system according to one embodiment may be implemented in various fields, including transportation. For instance, the multi-port converter system can be used for auxiliary power supplies for EVs.

In one embodiment, the auxiliary converters of the multi-port converter system may be configured to supply power to a plurality of loads (e.g., for the 12 V and 24 V batteries of an EV). The auxiliary converters can be integrated with the main DC-DC converter through a multiport converter (MPC) also described as an auxiliary converter system. The MPC may integrate power electronic components of the main powertrain with the auxiliary battery charger to achieve reduction in volume, weight, and cost without compromising the performance of the overall powertrain.

In one embodiment, an isolated MPC may charge the loads (e.g., both the 24 V and 12 V batteries) through a single charging architecture. More specifically, an MPC-based power supply can be configured to charge the 12 V and 24 V auxiliary batteries in an HD fuel cell (FC) EV powertrain. In contrast to conventional auxiliary power supply architectures, the multiport converter system may share the power electronic components of the main powertrain, yet it preserves the isolation and other target features of auxiliary power supplies in EV applications. The topology, design parameters, and control methodology for the multi-port converter system according to one embodiment are described herein.

### I. Overview of Multi-Port Converter Circuitry

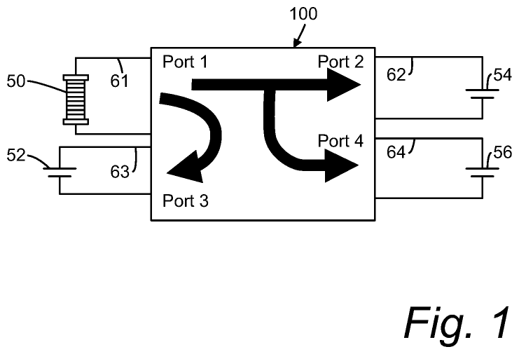

A multi-port converter system according to one embodiment is shown in FIG. 1 and generally designated 100. The multi-port converter system 100 is coupled to a power source 50, such as a fuel cell stack, via an input 61, and the multi-port converter system 100 may include an AC converter operable to supply power to a first output 63 based on the power received from the power source 50 via the input 61. The multi-port converter system 100 may generate power for multiple auxiliary outputs 62, 64 based on power obtained from the main converter according to one more embodiments described herein. The auxiliary outputs 62, 64 are shown as 24 V and 12 V DC outputs in the illustrated embodiment—however, the present disclosure is not so limited. The auxiliary outputs may correspond to any type of power output (AC or DC) and any level of voltage.

The first output 63 may supply power to a main load 52, which may correspond to a traction inverter for supplying power to a traction motor of a vehicle. The main load 52 may vary depending on the application. The auxiliary outputs 62, 64 may be respectively coupled to auxiliary loads 54, 56. These loads 54, 56 in the illustrated embodiment correspond to batteries b12, b24 that are in turn coupled to additional loads; however, each of the auxiliary loads 54, 56 may be any type of load or loads.

In one embodiment, as described herein, the multi-port converter system 100 may include a plurality of auxiliary converters, each configured to supply power to the plurality of auxiliary outputs 62, 64, and configured to operate in an interleaved manner for such supply of power to the plurality of auxiliary output 62, 64. Each of the plurality of auxiliary converters may be operably coupled to an AC signal present in the main converter that supplies power to the first output 63. In this way, the plurality of auxiliary converters may leverage circuitry of the main converter, reducing the number of components of the multi-port converter system 100 over conventional approaches. For instance, a quasi-AC voltage may be present between two nodes of the main converter, and this quasi-AC voltage may be used as an input to an auxiliary converter for generating more than one voltage output for the auxiliary ports 62, 64.

### II. Multi-Port Converter

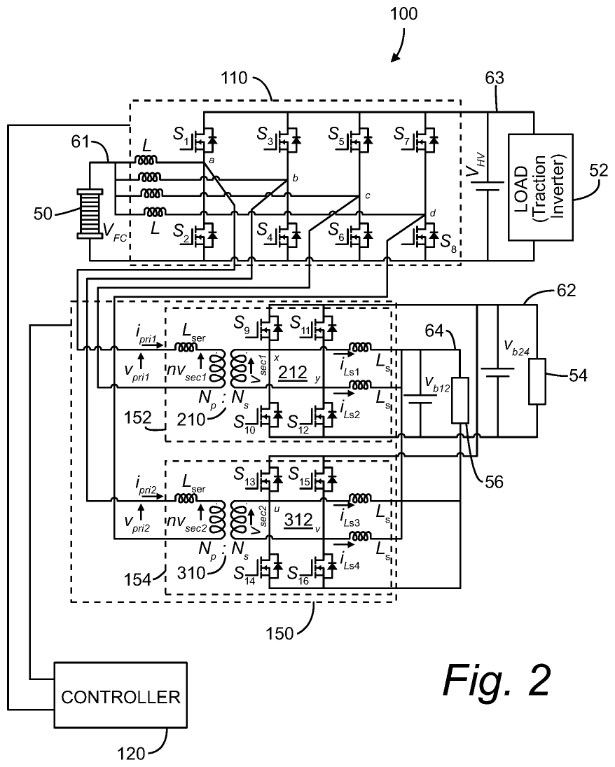

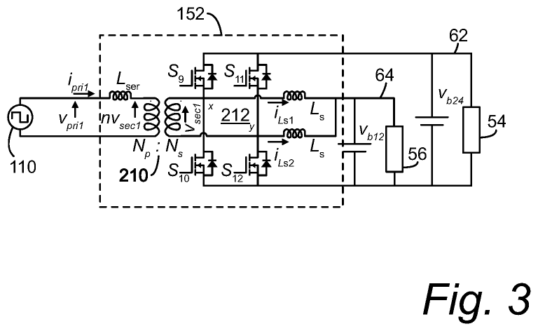

A multi-port converter system 100 according to one environment is shown in further detail in FIGS. 2-3. The multi-port converter system 100 includes an input 61 operable to receive power from a power source 50, such as a fuel cell stack. The multi-port converter system 100 may include a main converter 110 operable to supply power to a first output 63 and a main load 52 connected thereto based on power received from the power source 50 via the input 61. The multi-port converter system 100 may include an auxiliary converter system 150 with one or more auxiliary converters, such as first and second auxiliary converters 152, 154 depicted in the illustrated embodiment. The auxiliary converter system 150 may be coupled to the second and third outputs 62, 64 for supply of power thereto, such as 24 V and 12 V power respectively. Each of the one or more auxiliary converters of the auxiliary converter system 150 may be configured to supply power to each of the second and third outputs 62, 64. It is to be understood that—although two power outputs 62, 64 are described—the present disclosure is not so limited and more than two power outputs may supply power by one or more auxiliary converters of the auxiliary converter system 150. It is also to be understood that although each of the one or more auxiliary converters of the auxiliary converter system 150 supplies power to each of the power outputs 62, 64 in the illustrated embodiment, the auxiliary converter system 150 may be configured differently so that an auxiliary converter of the auxiliary converter system 150 may supply power to a subset of the available power outputs 62, 64 and corresponding loads 54, 56.

The multi-port converter system 100, as described herein, may include a plurality of switches operable to direct operation thereof. Control over the switches may be conducted in a variety of ways depending on the application. In the illustrated environment, a controller 120 may be provided and configured to control the switches of the multi-port converter system 100. Optionally, one or more sensors may be coupled to circuitry of the multi-port converter system 100 and provide feedback to the controller 120 so that, in one embodiment, the controller may direct operation of the switches based on feedback from the sensors.

The controller 120 may include any and all electrical circuitry and components to carry out the functions and algorithms described herein. Generally speaking, the controller 120 may include one or more microcontrollers, microprocessors, and/or other programmable electronics that are programmed to carry out the functions described herein. The controller 120 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs), and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions of the multi-port converter system 100, or they may reside in a common location within the multi-port converter system 100. When physically distributed, the components may communicate using any suitable serial or parallel communication protocol, such as, but not limited to, CAN, LIN, Fire Wire, I2C, RS-232, RS-485, and Universal Serial Bus (USB).

The main converter 110 in the illustrated embodiment may be configured as a DC-DC converter operable to convert DC power from the power source 50 into DC power for the first output 63 and a corresponding load 52. The main converter 110 may utilize multiple converter phases operating in parallel but with interleaved switch timing, enabling high current supply of power to the first output 63 in an efficient manner.

The multiple converter phases, also described as phase legs or stages, may each be substantially identical stages operable in conjunction with each other to supply power to the first output 63. Each phase may include a high-side switch S1, S3, S5, S7 and a low-side switch S2, S4, S6, S8. The high-side switch and the low-side switch may be operable in conjunction with each other to supply power to the first output 63. The high-side switches S1, S3, S5, S7 and the low-side switches S2, S4, S6, S8 may operate in conjunction with each other for each phase or stage so that each phase or stage is controlled to switch at substantially the same frequency but with a phase shift relative to each other. For instance, for two phases or stages, the switches may be operated 180° apart, and for three phases, the switches may be operated 120° apart. This multi-stage aspect of the main converter 110 enables the main converter 110 to be scaled by adding additional stages to support higher current loads.

The main converter 110 may include a plurality of inductors L each respectively coupled between the input 61 and the mid-points a, b, c, d (e.g., mid-point nodes) between the high-side switches S1, S3, S5, S7 and a low-side switches S2, S4, S6, S8 of the phases or phase legs of the main converter 110. It is noted that, between any two of the mid-points a, b, c, d of the phase legs, an AC voltage signal may be provided. For instance, this AC voltage signal may be a quasi-AC voltage signal, which may be provided to the auxiliary converter system 150 as described herein.

The auxiliary converter system 150 in the illustrated embodiment includes a plurality of auxiliary converters, such as a first auxiliary converter 152 and a second auxiliary converter 154 depicted in FIG. 2. Each of the first and second auxiliary converters 152, 154 may be operatively coupled to the second and third outputs 62, 64 for supply of power to respective loads 54, 56. The first and second auxiliary converters 152, 154 may be operated in an interleaved manner to provide power to the second and third output 62, 64. The present disclosure is not limited to each of the plurality of auxiliary converters providing power to two outputs 62, 64 or the same outputs—for instance, the plurality of auxiliary converters may be operable to supply power to one or more power outputs, and one of the auxiliary converters may be operable to supply power to a different set of power outputs from another of the auxiliary converters.

In the illustrated embodiment of FIG. 2, the first auxiliary converter 152 and the second auxiliary converter 154 may be configured substantially the same. The first auxiliary converter 152 is shown separately from the second auxiliary converter 154 in the illustrated embodiment of FIG. 3.

In the illustrated embodiment, the first auxiliary converter 152 includes a transformer Nₚ:Nₛ, 210 and an inductor Lₛₑᵣ operably coupled to first and second phase legs or stages of the main converter 110 for receipt of AC power therefrom. The transformer Nₚ:Nₛ, 210 and an inductor Lₛₑᵣ may supply voltage vsec1 to auxiliary switching circuitry 212, which may be operated to cooperatively supply power to more than output port 62, 64. The auxiliary switching circuitry 212 and the transformer 210, in conjunction with the inductor Lₛₑᵣ, may generate different types of power for the respective plurality of output ports 62, 64.

The auxiliary switching circuitry 212 may include first and second auxiliary stages, each including a high side auxiliary switch and a low side auxiliary switch. For instance, the first auxiliary stage in the illustrated embodiment of FIG. 2 includes a high side switch S9 and a low side switch S10. And the second auxiliary stage includes a high side switch S11 and a low side switch S12.

The transformer 210 may receive current ipri1 and voltage vpri1 from first and second phase legs of the main converter 110, such as the mid-points a, d of the phase legs corresponding respectively to 1) the midpoint a of the high side switch S1 and low side switch S2 and 2) the midpoint d of the high side switch S7 and the low side switch S8. The current ipri1 and the voltage vpri1 may be AC, such as a quasi-AC sinusoidal signal.

The difference in voltage and current iLs1, iLs2 between midpoints of the auxiliary stages of the first auxiliary converter 152 (e.g., nodes x and y) may, themselves, form the basis for generating power for a power output via inductors Ls. In this way, multiple power outputs may be generated from the first auxiliary converter 152. For instance, although first and second auxiliary stages or phase legs are provided for the first auxiliary converter 152, third, fourth, and more auxiliary stages may be provided for the first auxiliary converter 152 from which the midpoints thereof between two auxiliary stages may be used as a basis for generating power for a power output. The type of power output (e.g., DC or AC and voltage level) may be determined based on the circuit configuration, such as the level of vsec1, inductance Ls, and switching operation of the auxiliary stages (e.g., for the high side switch S9 and a low side switch S10, and for the high side switch S11 and the low side switch S12).

The second auxiliary converter 154, as noted, is substantially similar to the first auxiliary converter 152, with the exception of obtaining AC power in the form of current ipri2 and the voltage vpri2 based on midpoints of phase legs of the main converter, such as between midpoints b, c corresponding to 1) the midpoint b of the high side switch S3 and low side switch S4 and 2) the midpoint c of the high side switch S5 and the low side switch S6.

Like the first auxiliary converter 152, the second auxiliary converter 154 includes a transformer Nₚ:Nₛ, 310 and an inductor Lₛₑᵣ operably coupled to first and second phase legs or stages of the main converter 110 for receipt of AC power therefrom. The transformer Nₚ:Nₛ, 310 and an inductor Lₛₑᵣ may supply voltage vsec2 to auxiliary switching circuitry 312, which may be operated to cooperatively supply power to more than output port 62, 64. The auxiliary switching circuitry 312 and the transformer 310, in conjunction with the inductor Lₛₑᵣ, may generate different types of power for the respective plurality of output ports 62, 64, similar to operation of the first auxiliary converter 152.

The auxiliary switching circuitry 312 may include first and second auxiliary stages, each including a high side auxiliary switch and a low side auxiliary switch. For instance, the first auxiliary stage in the illustrated embodiment of FIG. 2 includes a high side switch S13 and a low side switch S14. And the second auxiliary stage includes a high side switch S15 and a low side switch S16.

The difference in voltage and current iLs3, iLs4 between midpoints of the auxiliary stages of the second auxiliary converter 154 (e.g., nodes u and v) may, themselves, form the basis for generating power for a power output via inductors Ls, such as the third power output 64. In this way, multiple power outputs may be generated from the second auxiliary converter 154. For instance, although first and second auxiliary stages are provided for the second auxiliary converter 154, third, fourth, and more auxiliary stages may be provided for the second auxiliary converter 154 from which the midpoints thereof between two auxiliary stages may be used as a basis for generating power for a power output. The type of power output (e.g., DC or AC and voltage level) may be determined based on the circuit configuration, such as the level of vsec1, inductance Ls, and switching operation of the auxiliary stages (e.g., for the high side switch S13 and a low side switch S14, and for the high side switch S15 and the low side switch S16).

Outputs of the first and second auxiliary converters 152, 154 may be coupled together for the power outputs 62, 64. For instance, the power output 62, which is 24 VDC in FIG. 2 but may vary depending on the application, is connected to a corresponding output of both the first and second auxiliary converters 152, 154. And the power output 64 is connected to a corresponding output of both the first and second auxiliary converters 152, 154.

Switching control over the auxiliary switching circuitry 212, 312, via the controller 120, may be conducted in an interleaved manner so that the auxiliary switching circuitry 212 of the first auxiliary converter 152 is operated to supply power to the second and third output 62, 64 for one phase, and the auxiliary switching circuitry 312 of the second auxiliary converter 154 is operated to supply power to the second and third output 62,64 during another, different phase.

The multi-port converter system 100 in one embodiment includes an interleaved main converter 110 (e.g., a DC-DC converter), which may in turn supply power to a traction inverter for an EV application. The main converter 110 may be helpful to regulate the fluctuating voltage of the power source 50, such as fluctuations in the stack terminal voltage of a fuel cell stack.

In one embodiment, for an HD FC EV, the main powertrain may be rated at 360 kW, and the output of the DC-DC converter 110 may be maintained at a voltage of 650 V. The 24 V auxiliary supply of the auxiliary converter system 150 may be configured for an 8 kW rating while the 12 V auxiliary supply of the auxiliary converter system 150 may be configured for a rating of 2 kW (total of 10 KW). These numbers are commensurate for an HD EV—but the application and power ratings may vary depending on the application.

In one embodiment, depending on the fuel cell stack voltage or the voltage output of the power source 50, the main converter 110 (e.g., a DC-DC converter) can be configured as an interleaved buck or boost architecture. For instance, the FC stack voltage may be around 580 V (V_{FCmax}) to 460 V (V_{FCmin}). To maintain an output of 650 V (V_{HV}), the resulting main converter 110 is a boost converter. To handle the high power of 360 kW, multiple phases may be operated in parallel resulting in an interleaved boost DC-DC converter architecture. A 4-phase architecture is described herein for the main converter 110—although additional or fewer phases may be utilized depending on the application.

In one embodiment, the minimum (Dₘᵢₙ) and maximum (Dₘₐₓ) duty ratio for the main powertrain can be calculated as

$${D}_{min} = 1 - \frac{{V}_{Fcmax}}{{V}_{HV}} \qquad ( 1 )$$

$${D}_{max} = 1 - \frac{{V}_{Fcmin}}{{V}_{HV}} \qquad ( 2 )$$

Using (1) and (2), Dₘᵢₙ and Dₘₐₓ are 0.11 and 0.3 respectively. The midpoint of each phase leg a, b, c, d has a quasi-square voltage. The voltage between two such midpoints is alternating in nature. This voltage can be tapped and can be used as the input for an auxiliary converter 152, 154 of the auxiliary converter system 150 (e.g., for auxiliary battery charging) through a high frequency isolation transformer 210, 310. To accommodate the high current at the auxiliary charging level, two or more auxiliary converters 152, 154 may be interleaved (e.g., operated in parallel with a phase shift in the modulating carrier waves). The voltage signals for the auxiliary converter 152 are shown in FIG. 6, with representative waveforms depicted for the primary and secondary sides of the auxiliary converter 152.

The auxiliary converter 152 in the illustrated embodiments of FIGS. 2-3 is configured to supply power the second output 62 and the corresponding load 54 (e.g., a 24 V battery bus for charging) using a dual active bridge (DAB) mode of operation from the primary side, while supplying power to the third output 64 and the corresponding load 56 (e.g., the 12 V battery bus for charging) from the primary side via synchronous buck operation. The duty ratio on the secondary may be close to 50%, and therefore the secondary voltage of the transformer 210 may be a full square wave as shown in FIG. 6. In this configuration, no separate primary side power semiconductor switches or gate drivers may be necessary, thereby achieving a reduction in cost, weight, and volume.

For purposes of disclosure, the details of the powertrain for the main converter 110 and the load 52 (e.g., for a powertrain in an EV application) are described in conjunction with aspects that cooperate with the auxiliary converter system 150 for supply of power therefrom. Additional circuitry and modes of operation for the main converter 110 may be present. For each of Dₘᵢₙ and Dₘₐₓ, the auxiliary converter 152 may have four operating states corresponding to the minimum and maximum load conditions on the second and third outputs 62, 64 (e.g., a 24 V battery bus and a 12 V battery bus). The minimum load is taken as 5% of the rated load on each of the second and third outputs 62, 64, e.g., 100 W on the third output 64 (12 V bus) and 400 W on the second output 62 (24 V bus).

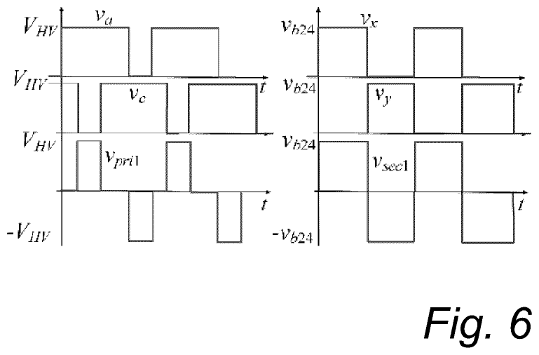

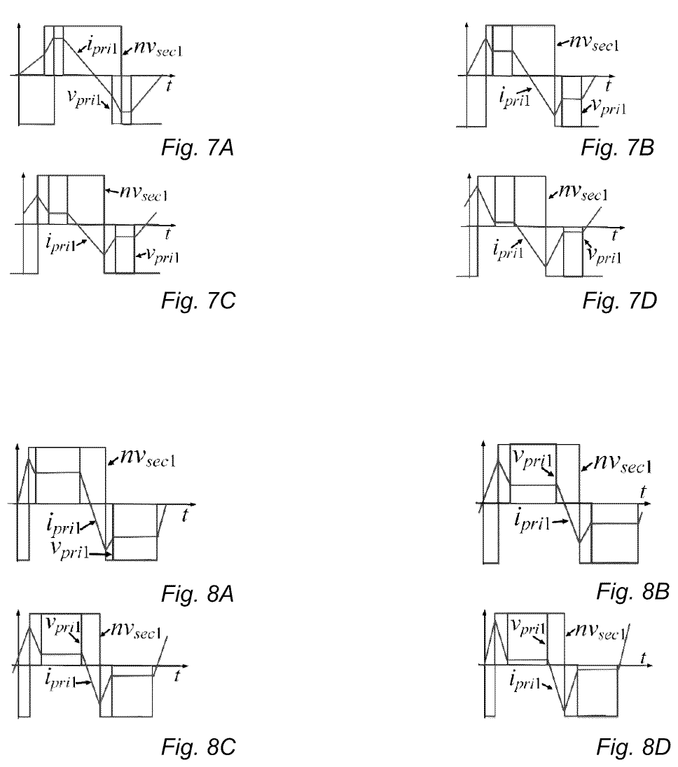

FIGS. 7A-D show waveforms at Dₘᵢₙ operating points for an auxiliary converter 152 in one embodiment, with representative voltage and current waveforms across Lₛₑᵣ at Dₘᵢₙ for (7A) 8 kW on the second output 62 and 2 kW on the third output 64, (7B) 8 kW on the second output 62 and 100 W on the third output 64, (7C) 400 W on the second output 62 and 2 kW on the third output 64, (7D) 400 W on the second output 62 and 100 W on the third output 64.

FIGS. 8A-D shows waveforms at Dₘₐₓ operating points for an auxiliary converter 152 in one embodiment, with representative voltage and current waveforms across Lₛₑᵣ at Dₘₐₓ for (8A) 8 kW on the second output 62 and 2 kW on the third output 64, (8B) 8 kW on the second output 62 and 100 W on the third output 64, (8C) 400 W on the second output 62 and 2 kW on the third output 64, (8D) 400 W on the second output 62 and 100 W on the third output 64.

Design parameters for the auxiliary charging system 150 in one embodiment include the primary side inductor Lₛₑᵣ, the transformer turns Nₚ:Nₛ (n), and the interleaved inductor Lₛ on the secondary side, as outlined in Table 1.

| V_{FCmin} | 460 | V |
|---|---|---|
| V_{FCmax} | 580 | V |
| V_{HV} | 650 | V |
| Dₘᵢₙ | 0.11 | |
| Dₘₐₓ | 0.3 | |
| f_{swit} | 70 | kHz |
| Lₛₑᵣ | 50 | uH |
| Lₛ | 10 | uH |

| | |
|---|---|
| N_{P}:Nₛ | 650:24 |

Table 1. Parameters and specifications for an auxiliary converter in one embodiment.

The value of Lₛₑᵣ may dictate the maximum power rating of the auxiliary converter 152 and may be selected for reduced or minimum duty ratio conditions corresponding to Dₘᵢₙ, shown in FIG. 7A. For total power rating of 10 kW, considering the maximum phase shift (of 90 degrees), the value for Lₛₑᵣ may be calculated as 50 μH.

The transformer turns ratio may be selected such that the transformer primary and secondary voltages are properly matched, e.g., V_{HV}=nV_{b24}. This selection may decrease the transformer RMS current, and the conduction losses. Irrespective of the primary side duty ratio, the input to the primary side of the isolation transformer 210 may be a quasi-square wave of magnitude V_{HV} (650 V). Therefore, the transformer turns ratio may be selected as 650:24 although this may vary depending on the application.

The value of Lₛ may be selected to control the zero voltage switching (ZVS) of the secondary side switches (e.g., the auxiliary switching circuitry 212), by controlling the ripple current. Ls may be determined such that at low load conditions, the current through the secondary switches during turn-on is sufficiently negative to discharge the output capacitance Cₒₛₛ across each switch S9, S10, S11, S12. This can be mathematically expressed as

$${\int }_{0}^{{T}_{del}} {i}_{s w} d t = {\int }_{0}^{{V}_{b 24}} {C}_{o s s} d V \qquad ( 3 )$$

Equation (3) may be derived considering the ripple current to have enough energy to discharge the voltage across the switch during the dead time between the switches in the phase leg. The peak value of i_{sw} may be dependent on Ls and therefore equation 3 may serve as the basis to determining Lₛ. For the given configuration with a high step down ratio of 650:24, the choice of Lₛ may be flexible to ensure ZVS of the secondary switches over a wide range in the output power. These numbers are flexible, and the design parameters may be changed on variations of these numbers for different power trains. The design methodology, however, remains similar with variations in the parameters.

The output side being at low voltage may have a significant output ripple. This high ripple can be detrimental to the loads 54, 56 (e.g., to a battery) and so a large capacitor bank may be utilized to absorb a high ripple current. The capacitors' RMS current for the third output 64 may be around 10 Amps due to the superimposed 180° phase shifted currents. On the other hand, the capacitor for the second output 62 may absorb 900 Amps RMS current, which involves a larger capacitor bank. The auxiliary converter 152 may be operating at 70 kHz, and with two interleaved converters 152, 154, the ripple frequency is around 280 kHz, thus the capacitance requirement is lower, or minimum.

A high-current and high-frequency capacitor bank configuration can increase complexity. In terms of capacitor technologies, two types can be considered for the auxiliary converter 152, 154: film and/or ceramic. The film/polymer capacitors are one of the more affordable but have limited operating temperatures and low energy density, which makes them bulky. Furthermore, the film capacitor architecture shows large equivalent series inductance (ESL), which can affect practicality for high-frequency inverter applications, such as the multiport converter system 100.

In contrast, the multilayer ceramic capacitor has high energy density, higher current conduction capability, and high-temperature operation. These characteristics make it a useful candidate for the converter system 150 for achieving reduced or minimum volume. Although the packaging of many discrete capacitors can increase the volume and layout inductance, doing so according to one embodiment may be much smaller and better performing than the film capacitor bank.

### III. N-Port Converter

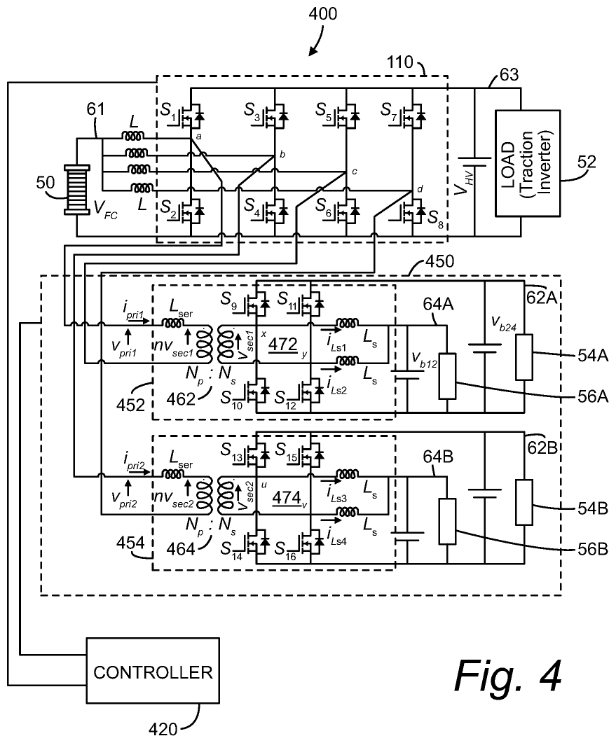

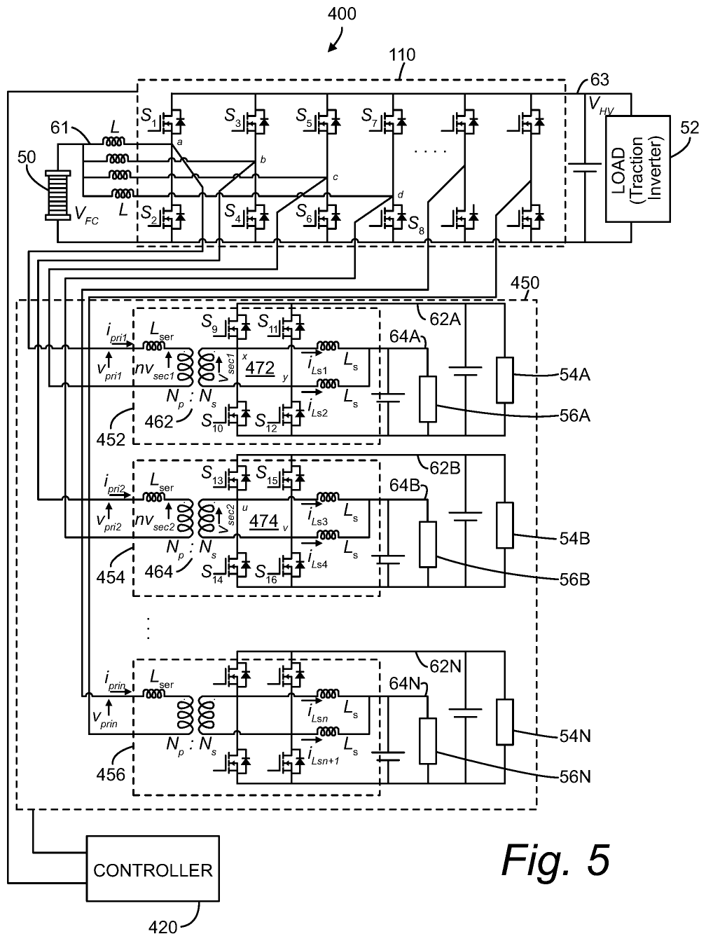

A multi-port converter system 400 according to one embodiment is shown in further detail in FIGS. 4-5. The multi-port converter system 400 includes an input 61 operable to receive power from a power source 50, such as a fuel cell stack. The multi-port converter system 400 may include a main converter 110 operable to supply power to a first output 63 and a main load 52 connected thereto based on power received from the power source via the input 61, the same as the multi-port converter system 100. The main converter 110 in the illustrated embodiment of FIG. 5 is shown with more than four phase legs, which is an option described herein with respect to the main converter 110.

The multi-port converter system 400 may include an auxiliary converter system 450 with one or more auxiliary converters, such as the first and second auxiliary converters 452, 454, 456 depicted in the illustrated embodiments. The auxiliary converter system 450 may be similar to the auxiliary converter system 150 with the exception of each auxiliary converter 452, 454, 456 being configured to supply power to separate outputs 62A, 62B . . . 62N and outputs 64A, 64B . . . 64N.

The multi-port converter system 400, similar to the multi-port converter 100, may include a plurality of switches operable to direct operation thereof. Control over the switches may be conducted in a variety of ways depending on the application. In the illustrated environment, a controller 420, similar to the controller 120, may be provided and configured to control the switches of the multi-port converter system 400. Optionally, one or more sensors may be coupled to circuitry of the multi-port converter system 400 and provide feedback to the controller 420 so that, in one embodiment, the controller may direct operation of the switches based on feedback from the sensors.

The auxiliary converter system 450 in the illustrated embodiment includes a plurality of auxiliary converters 452, 454, 456. Each of the auxiliary converters 452, 454, 456 may be operatively coupled to respective outputs 62A, B . . . N, 64A, B . . . N for supply of power to respective loads 54A, B . . . N, 56A, B . . . N. The present disclosure is not limited to each of the plurality of auxiliary converters providing power to separate outputs 62A, B . . . N, 64A, B . . . N—for instance, two or more of the auxiliary converters 452, 454, 456 may be operable to supply power to shared power outputs.

In the illustrated embodiment, the first auxiliary converter 452 includes a transformer Nₚ:Nₛ, 462 and an inductor Lₛₑᵣ operably coupled to first and second phase legs or stages of the main converter 110 for receipt of AC power therefrom. The transformer Nₚ:Nₛ, 472 and an inductor Lₛₑᵣ may supply voltage vsec1 to auxiliary switching circuitry 472, which may be operated to cooperatively supply power to more than output port 62A, 64B. The auxiliary switching circuitry 472 and the transformer 462, in conjunction with the inductor Lₛₑᵣ, may generate different types of power for the respective plurality of output ports 62A, 64B.

The second and Nth auxiliary converters 254, 256, as noted, may be substantially similar to the first auxiliary converter 452, with the exception of obtaining AC power in the form of current ipri2 . . . iprin and the voltage vpri2 . . . vprin based on midpoints of phase legs of the main converter, such as, for the auxiliary converter 254, between midpoints b, c corresponding to 1) the midpoint of the high side switch S3 and low side switch S4 and 2) the midpoint of the high side switch S5 and the low side switch S6. The Nth auxiliary converter 256 may be coupled to the respective midpoints of additional phase legs of the main converter, similar to the coupling shown in FIG. 5.

Like the first auxiliary converter 152, the second auxiliary converter 154 includes a transformer Nₚ:Nₛ, 464 and an inductor Lₛₑᵣ operably coupled to first and second phase legs or stages of the main converter 110 for receipt of AC power therefrom. The transformer Nₚ:Nₛ, 464 and an inductor Lₛₑᵣ may supply voltage vsec2 to auxiliary switching circuitry 472, which may be operated to cooperatively supply power to more than output port 62B, 64B. The auxiliary switching circuitry 464 and the transformer 472, in conjunction with the inductor Lₛₑᵣ, may generate different types of power for the respective plurality of output ports 62B, 64B, similar to operation of the first auxiliary converter 452.

The auxiliary switching circuitry 474 may include first and second auxiliary stages, each including a high side auxiliary switch and a low side auxiliary switch. For instance, the first auxiliary stage in the illustrated embodiment of FIGS. 4 and 5 includes a high side switch S13 and a low side switch S14. And the second auxiliary stage includes a high side switch S15 and a low side switch S16. The Nth auxiliary converter 456 may be configured similarly with first and second auxiliary stages, each including a high side auxiliary switch and a low side auxiliary switch.

### IV. Control Methodology for the Converter

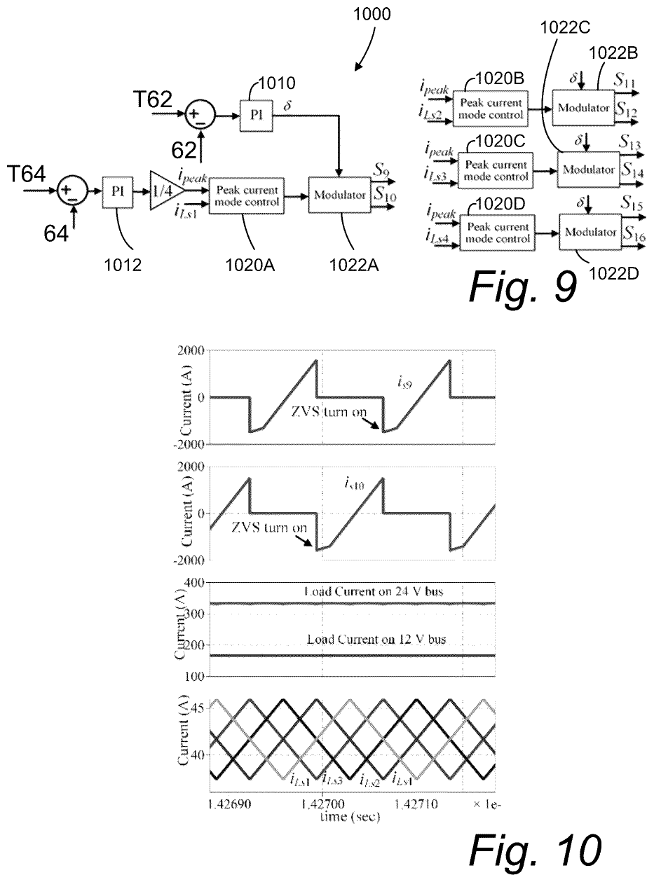

Control over the multi-port converter system 100 may vary depending on the application. One example methodology is depicted in FIG. 9 as a control diagram and generally designated 1000. The control methodology 1000, or aspects thereof, may be implemented by the controller 120, 420.

The control methodology 1000 in the illustrated embodiment may be configured for supplying power to the loads 54, 56 via the second and third outlets 62, 64 (e.g., so that 24 V and 12 V batteries are charged). This control methodology may involve control over an auxiliary converter to power more than one of the loads 54, 56. The control methodology 1000 may operate to decouple and independently control the load power at each outlet 62, 64 (e.g., the battery bus).

The power output 62 controlled by a proportional-integral (PI) controller-based phase shift controller 1010 to control operation toward a first target T62. The phase shift between the primary and secondary side bridge may achieve the target power flow. This control is operable in a manner similar to a phase shifted DAB control.

The power output 64 may be controlled by a PI controller 1012 to maintain the output of the power output 64 toward a second target T64, with the PI controller 1012 followed by a peak current mode controller 1020A-D. The inner current controllers may ensure substantially equal current sharing among the four interleaved phases on the power output 64 and provide natural protection against short circuit fault in any of the phases.

The phase shift from the PI voltage controller 1010 for the output 62 and the duty ratio output from the current mode controller 1020A-D is used to generate gate pulses for each of the switches S9-S16. Modulators 1022A-D may be provided to drive the switches S9-S16 of the auxiliary converter system 150 based on output from the PI controller 1010 and the PI controller 1012.

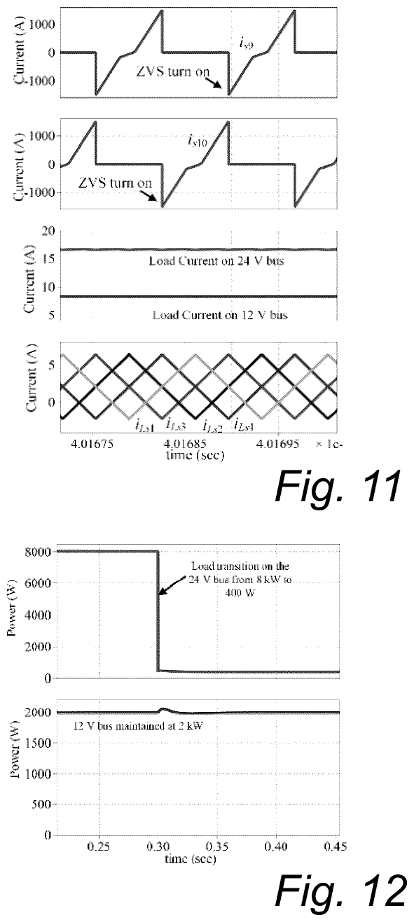

FIG. 10 depicts the switch current load and secondary side inductor current at full load conditions at Dₘᵢₙ (in the context of an 8 kW, 24 V supply to the second output 62 and a 2 kW, 12 V supply to the third output 64). FIG. 11 shows the results a 5% load—i.e., 400 W, 24 V supply to the second output 62 and a 100 W, 12 V supply to the third output 64. In both full and 5% conditions, zero voltage switching of the secondary switches S9-S16 may be substantially ensured, and this can be confirmed from the significant negative values of the switch currents during switching. The four-phase interleaved current on the inductors are also shown in FIGS. 10 and 11.

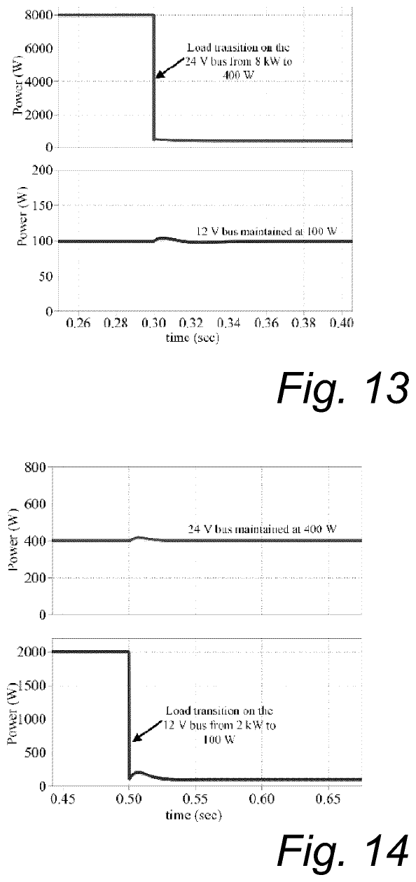

Performance of the control during load changes at the second and third outputs 62, 64 are shown simulated in FIGS. 12 and 13, which show the transients on the third output 64 power during load transition on the second output 62. FIG. 12 depicts decoupled load power control of the 12 V and 24 V buses (e.g., second output 62 and third output 64) during load transition on the 24 V bus from 8 kW to 400 W with 12 V bus maintained at 2 kW. FIG. 13 depicts decoupled load power control of the 12 V and 24 V buses (e.g., second output 62 and third output 64) during load transition on the 24 V bus from 8 kW to 400 W with 12 V bus maintained at 100 W.

Turning to FIG. 14, the transients on the second power output 62 during load transition on the third power output 64 are shown. FIG. 14 depicts decoupled load power control of the 12 V and 24 V buses (e.g., second output 62 and third output 64) during load transition on the 12 V bus from 2 kW to 100 W with 24 V bus maintained at 400 W.

The results depicted in FIGS. 11-14 show that during transition of load on one bus the output power on the other bus was maintained constant by the control methodology, and a change in load in any of the outputs 62, 64 may not affect the other.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A powertrain of a heavy-duty electric vehicle (HD EV), the powertrain comprising:
a fuel-cell (FC) stack;
an inverter DC bus, a 12 V battery bus, and a 24 V battery bus; and
a multiport converter (MPC) including:
an input port, and first, second, and third output ports;
interleaved DC-DC converter circuitry including first, second, third, and fourth phase legs, wherein the interleaved DC-DC converter circuitry is electrically coupled to the FC stack through the input port and to the inverter DC bus through the first output port;
a first auxiliary power-supply circuitry including a first isolation transformer and fifth and sixth phase legs, wherein the fifth and sixth phase legs are electrically coupled to respective mid-points of the first and third phase legs through the first isolation transformer, to the 12 V battery bus through the second output port, and to the 24 V battery bus through the third output port; and
a second auxiliary power-supply circuitry including a second isolation transformer and seventh and eighth phase legs, wherein the seventh and eighth phase legs are electrically coupled to 1) respective mid-points of the second and fourth phase legs through the second isolation transformer, 2) the 12 V battery bus through the second output port, and 3) the 24 V battery bus through the third output port, wherein the first auxiliary power-supply circuitry and the second auxiliary power-supply circuitry are interleaved.

2. The powertrain of claim 1, wherein the phase legs each includes a respective half bridge.

3. The powertrain of claim 1, wherein the interleaved DC-DC converter circuitry is configured as a buck converter or a boost converter.

4. The powertrain of claim 1, comprising controller circuitry communicatively coupled with the MPC and configured to control the first auxiliary power-supply circuitry and the second auxiliary power-supply circuitry in a decoupled manner.

5. The powertrain of claim 1, comprising:
a traction inverter electrically coupled with the MPC through the inverter DC bus; and
a motor electrically coupled with the traction inverter.

6. A converter system for a heavy-duty electric vehicle (HD EV), the converter system comprising:
a DC source;
a traction inverter DC bus, a first auxiliary bus, and a second auxiliary bus;
a multiport converter (MPC) including:
an input port, and first, second, and third output ports;
first interleaved converter circuitry electrically coupled to the DC source through the input port and to the traction inverter DC bus through the first output port, the first interleaved converter circuitry corresponding to a DC-DC converter and including a first AC voltage and a second AC voltage; and
second interleaved converter circuitry operably coupled to the first AC voltage and the second AC voltage of the first interleaved converter circuitry, the second interleaved converter circuitry configured to provide first DC voltage, based at least in part on the first AC voltage, to the first auxiliary bus through the second output port, the second interleaved converter circuitry configured to provide second DC voltage, based at least in part on the second AC voltage, to the second auxiliary bus through the third output port.

7. The converter system of claim 6, wherein the second interleaved converter circuitry includes:
first auxiliary converter circuitry operably coupled to the first AC voltage of the first interleaved converter circuitry, the first auxiliary converter circuitry operably coupled to the second output port to provide power to the second output port; and
second auxiliary converter circuitry operably coupled to the second AC voltage of the first interleaved converter circuitry, the second auxiliary converter circuitry operably coupled to the third output port to provide power to the third output port.

8. The converter system of claim 7, comprising controller circuitry communicatively coupled with the first and second interleaved converter circuitries and configured to control the first auxiliary converter circuitry and the second auxiliary converter circuitry in a decoupled manner.

9. The converter system of claim 7, wherein the first auxiliary converter circuitry is operably coupled to the third output port to provide power to the third output port, and wherein the second auxiliary converter circuitry is operably coupled to the second output port to provide power to the second output port.

10. The converter system of claim 9, wherein the first auxiliary converter circuitry and the second auxiliary converter circuitry are operated in an interleaved manner to provide power to both the second output port and the third output port to respectively generate the first DC voltage for the second output port and the second DC voltage for the third output port.

11. The converter system of claim 7, wherein:
the first interleaved converter circuitry includes first, second, third, and fourth phase legs;
the first auxiliary converter circuitry includes a first isolation transformer and fifth and sixth phase legs, wherein the fifth and sixth phase legs are electrically coupled to respective mid-points of the first and third phase legs through the first isolation transformer, to the first auxiliary bus through the second output port, and to the second auxiliary bus through the third output port; and
a second auxiliary converter circuitry includes a second isolation transformer and seventh and eighth phase legs, wherein the seventh and eighth phase legs are electrically coupled to 1) respective mid-points of the second and fourth phase legs through the second isolation transformer, 2) the first auxiliary bus through the second output port, and 3) the second auxiliary bus through the third output port, wherein the first auxiliary converter circuitry and the second auxiliary converter circuitry are interleaved.

12. The converter system of claim 11, wherein the first, second, third, fourth, fifth, and sixth phase legs each includes a respective half bridge.

13. The converter system of claim 11, wherein the first interleaved converter circuitry is configured as a buck converter or a boost converter.

14. The converter system of claim 6, comprising:
a traction inverter electrically coupled with the first interleaved converter circuitry through the traction inverter DC bus; and
a motor electrically coupled with the traction inverter.

15. A converter system comprising:
a DC source;
a traction inverter DC bus, a first auxiliary bus, and a second auxiliary bus;
a multiport converter (MPC) including:
an input port, and first, second, and third output ports;
first interleaved converter circuitry electrically coupled to the DC source through the input port and to the traction inverter DC bus through the first output port, the first interleaved converter circuitry corresponding to a DC-DC converter and including a first AC voltage and a second AC voltage; and
second converter circuitry operably coupled to the first AC voltage and the second AC voltage of the first interleaved converter circuitry, the second converter circuitry configured to provide first DC voltage, based at least in part on the first AC voltage, to the first auxiliary bus through the second output port, the second converter circuitry configured to provide second DC voltage, based at least in part on the second AC voltage, to the second auxiliary bus through the third output port.

16. The converter system of claim 15, wherein the second converter circuitry includes:
first auxiliary converter circuitry operably coupled to the first AC voltage of the first interleaved converter circuitry, the first auxiliary converter circuitry operably coupled to the second output port to provide power to the second output port; and
second auxiliary converter circuitry operably coupled to the second AC voltage of the first interleaved converter circuitry, the second auxiliary converter circuitry operably coupled to the third output port to provide power to the third output port.

17. The converter system of claim 16, wherein the first auxiliary converter circuitry is operably coupled to the third output port to provide power to the third output port, and wherein the second auxiliary converter circuitry is operably coupled to the second output port to provide power to the second output port.

18. The converter system of claim 17, wherein the first auxiliary converter circuitry and the second auxiliary converter circuitry are operated in an interleaved manner to provide power to both the second output port and the third output port to respectively generate the first DC voltage for the second output port and the second DC voltage for the third output port.

19. The converter system of claim 16, comprising controller circuitry communicatively coupled with the first interleaved converter circuitry and the second converter circuitry and configured to control the first auxiliary converter circuitry and the second auxiliary converter circuitry in a decoupled manner.

20. The converter system of claim 16, wherein the second converter circuitry includes third auxiliary converter circuitry operably coupled to an AC voltage of the first interleaved converter circuitry, the third auxiliary converter circuitry operably coupled to a fourth output port to provide power to the fourth output port.
